(19) United States
(12) Patent Application Publication
(10) Pub. No.: US 2008/0006744 A1
(43) Pub. Date: Jan. 10, 2008

(54) Adjustable supporting device for monitor

(76) Inventor: John Sun, Taipei County (TW)

Correspondence Address: BIRCH STEWART KOLASCH & BIRCH, PO BOX 747, FALLS CHURCH, VA, 22040-0747, US

(21) Appl. No.: 11/478,697

(22) Filed: Jul. 3, 2006

(51) Int. Cl. F16M 11/00

(52) U.S. Cl. 248/161; 248/919

(57) ABSTRACT

An adjustable supporting device for monitor can be extended to adjust elevation and anchored rapidly to support a loading article. It includes at least a base containing an extendable trough, an extendable post inserting in the extendable trough to proceed an extending displacement or a retracting displacement, and an anchor means located on the extendable post to anchor the extendable post on the base. The extendable post can proceed the extending displacement whenever desired and generate an one-way anchoring effect during extending without retracting. Upon the extendable post is extended to a top stop, it can be retracted smoothly to proceed the retracting displacement.

### FIELD OF THE INVENTION

The present invention relates to a supporting device and particularly to a supporting device that can adjust the height rapidly to support a monitor or the like at a desired elevation.

### BACKGROUND OF THE INVENTION

Supporting device is a mechanism widely used in household goods to hold the goods steadily at a desired location. However some goods require to be adjusted frequently at varying elevations during use. Or different users require different elevations during use of the goods. For instance, the elevation of monitors often has to be adjusted according to ergonomics.

In order to facilitate elevation adjustment of holding goods, many types of supporting device or structure have been developed in prior art to enable users or vendors to do adjustment. References can be found as follows:

Japan patent publication No. 2003-029653.

China patent publication Nos. CN1595539A, CN1690789A, CN1767073A, CN1763593A and CN1477442A.

R.O.C. patent Nos. M270629, M281256, I231894; and patent publication Nos. 591286, 498140, and 528916.

U.S. Pat. Nos. 4,690,362, 5,769,369, 5,812,368, 6,134,103, 6,189,849, 6,352,226, 6,354,552, 6,378,830, 6,651,943, 6,655,645, 6,702,238, 6,712,321, 6,733,094, 6,796,537 and 6,769,538; and patent publication Nos. 2005/0236533 A1 and 2003/0189155 A1.

However, some of the conventional supporting devices can only adjust the swiveling angle and cannot adjust the elevation. Some supporting devices can adjust the elevation but adopt a coil spring to provide stretching force, and are difficult to use. Moreover, the monitor is difficult to be adjusted at an optimal elevation due to issues such as the weight and gravity center of the monitor. Some other supporting devices adopt a toggle mechanism that has to unfasten a turning knob on the joint to adjust the angle of the toggle lever in order to make elevation adjustment for the monitor, and fasten the turning knob again after the adjustment is finished so that the monitor can be held at a desired elevation. The operation is tedious. Moreover, after the turning knob is unfastened, many hazards could happen, such as the monitor could drop and users could be clamped and hurt. Some supporting devices perform elevation adjustment by rotating a screw bar. Such an operation also is not convenient.

### SUMMARY OF THE INVENTION

In view of the forepart problems occurred to the conventional supporting devices, the present invention aims to provide an improved supporting device to make utilization easier.

The adjustable supporting device for monitor according to the invention includes at least a base containing an extendable trough, an extendable post inserting in the extendable trough that has an extending displacement and a retracting displacement, and an anchor means located on the extendable post to anchor the extendable post on the base. The extendable trough has a wall with at least one guiding flute formed thereon. The guiding flute has a plurality of inclined anchor notches each has an upward opening. The anchor means includes at least a swaying bar located in the guiding flute and an elastic element coupling with the swaying bar to urge the swaying bar into the anchor notches such that the extendable post can only be extended outwards according to the extending displacement and cannot proceed the retracting displacement to form an one-way anchoring and supporting condition. A confining element also is provided abutting the swaying bar to prevent the swaying bar from entering the anchor notches. The swaying bar harnesses the confining element when the extendable post is moved to a top stop and action of the retracting displacement starts so that the retracting process is not hindered. While the extendable post is extended to proceed the extending displacement, the harness on the swaying bar is released and one-way anchoring and supporting condition is resumed.

In addition, the extendable post has a switch trough located at an elevation higher than the confining element to make the confining element slidably located in the switch trough. The confining element presses the base and has a step confining trough to confine the swaying bar. The step confining trough has a wider action zone on an upper end and a narrower confining zone on a lower end.

When the extendable post is extended to proceed the extending displacement, the confining element is dragged by the base and moved to the bottom of the switch trough. The action zone confines the swaying bar so that the swaying bar can freely enter each anchor notch sequentially while the extendable post is extending outwards. During this process if the extendable post is moved inversely to proceed the retracting displacement, the swaying bar is latched in the anchor notch. As the swaying bar already is located in the anchor notch, the confining element is not switched to confine the swaying bar through the confining zone even it is dragged by the base and lifted slightly higher against the switch trough. Thereby the extendable post can only proceed the extending displacement and cannot proceed the retracting displacement to form the one-way anchoring and supporting condition.

When the extendable post is located at the top stop and proceeds the retracting displacement, the confining element is dragged by the base and moved to the top end of the switch trough. At that moment the swaying bar is located in the guiding flute. Hence the confining element is switched to confine the swaying bar through the confining zone, and harnessing of the confining element on the swaying bar starts. As the swaying bar cannot enter the anchor notches in this condition, the extendable post can process the retracting displacement smoothly without being hindered. During this process if the extendable post is moved inversely to proceed the extending displacement, the confining element is dragged by the base and moved to the bottom of the switch trough, so that the confining element is switched again with the action zone to match the swaying bar.

In short, the extendable post of the invention may be put in the following operation conditions:

1. The extendable post can proceed the extending displacement to generate one-way anchoring and supporting effect while proceeding the retracting displacement is prohibited at the same time.

2. To proceed the retracting displacement the extendable post has to be moved and extended to the top stop, then the extendable post can be moved downwards and retracted smoothly.

3. After the extendable post has started proceeding the retracting displacement, the extending displacement operation and one-way anchoring and supporting effect can be resumed by directly extending the extendable post.

Compared with the prior art, the invention provides at least the following benefits:

1. By merely moving the extendable post, extension and retraction, and anchoring and release of anchoring can be accomplished. Operation is simple and easy.

2. Anchoring can be accomplished rapidly.

3. Release of anchoring can be accomplished rapidly.

4. Anchoring and release of anchoring can be accomplished without using extra adjustment tools.

5. The structure is simpler. It is also more durable than the previous techniques.

6. It is stronger and can support more loading than the conventional supporting devices.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an embodiment of the invention in a use condition.

FIG. 2 is an exploded view of an embodiment of the invention.

FIG. 3 is a schematic view of an embodiment of the invention showing the extendable post and anchor means in a coupling condition.

FIG. 4 is a schematic view of an embodiment of the invention showing the extendable post located at a bottom stop.

FIG. 5 is a schematic view of an embodiment of the invention showing the extendable post in an extending condition.

FIG. 6 is a schematic view of an embodiment of the invention showing the extendable post located at a top stop.

FIG. 7 is a schematic view of an embodiment of the invention showing the extendable post in a retracting condition.

FIG. 8 is a schematic view of another embodiment of the confining element of the invention.

FIG. 9 is a schematic view of an embodiment of the invention showing the base and extendable post are interposed by a sliding track.

FIG. 10 is a schematic view of another embodiment of the base of the invention.

FIG. 11 is a schematic view of yet another embodiment of the base of the invention.

FIG. 12 is a schematic view of another embodiment of the extendable post of the invention.

FIG. 13 is a schematic view of yet another embodiment of the extendable post of the invention.

FIG. 14 is a schematic view of an embodiment of the anchor notch of the invention.

FIG. 15 is a schematic view of another embodiment of the anchor notch of the invention.

FIG. 16 is a schematic view of another embodiment of the invention in a use condition.

### DETAILED DESCRIPTION OF THE PREFERRED EMBODIMENTS

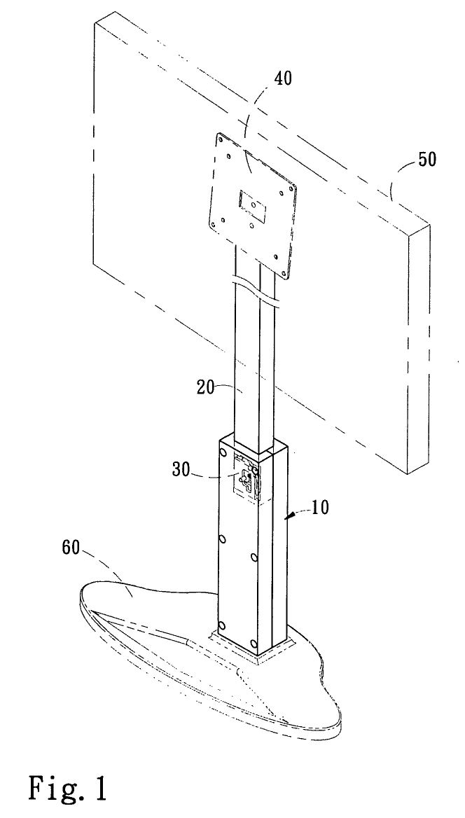

Please refer to FIG. 1 for an embodiment of the supporting device of the invention. It mainly includes a base 10, an extendable post 20 and an anchor means 30. The extendable post 20 may have a monitor holding dock 40 to hold a monitor 50. The base 10 may be mounted on a base dock 60 to support the monitor 50 more steadily without toppling.

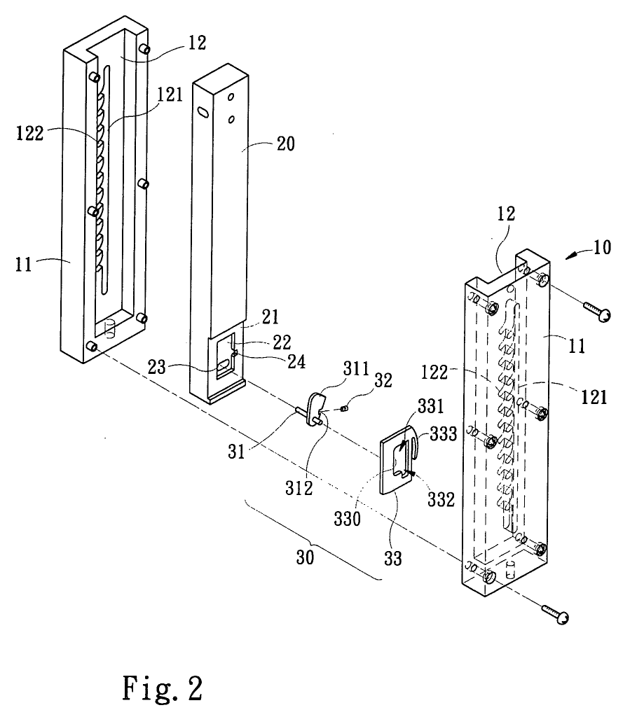

Refer to FIG. 2 for the structural relationship among the base 10, extendable post 20 and anchor means 30. The base 10 consists of two shells 11 that are fastened through screws to form an extendable trough 12 inside to be inserted by the extendable post 20. The extendable trough 12 has at least one guiding flute 121 or two symmetrical guiding flutes 121. Each guiding flute 121 has a plurality of inclined anchor notches 122 on one side with upward openings.

The extendable post 20 is held in the extendable trough 12 and can be extended and retracted relative to the base 10 to proceed an extending displacement and a retracting displacement. The extendable post 20 has a switch trough 21 on the bottom end. The switch trough 21 includes a swaying trough 22 which has a through slot 23 and a wedging cavity 24 on one side.

The anchor means 30 includes a swaying bar 31, an elastic element 32 and a confining element 33. The swaying bar 31 is fixedly surrounded by a swaying plate 311. The swaying plate 311 has a notch 312 on one side. The confining element 33 has a step confining trough 330 which has a wider action zone 331 on an upper end and a narrower confining zone 332 on a lower end.

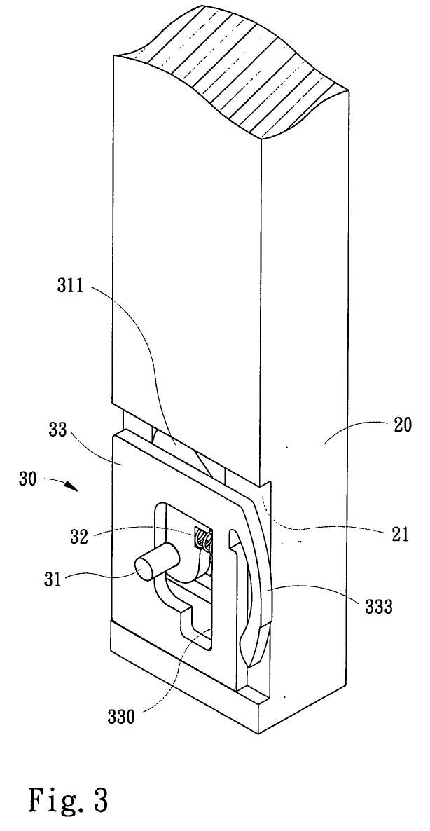

For assembly, the swaying bar 31 has one end running through the through slot 23 into one guiding flute 121, and another end running through the step confining trough 330 into another symmetrical guiding flute 121. The swaying plate 311 is located in the swaying trough 22. The elastic element 32 bridges the wedging cavity 24 and the notch 312 so that the elastic element 32 can push the swaying plate 311 and indirectly press the swaying bar 31, thereby when the swaying bar 31 is held in the guiding flute 121 it can sway towards one side where the anchor notch 122 is located in normal conditions. The confining element 33 is slidably located in the switch trough 21 abutting the swaying bar 31. The switch trough 21 is located at an elevation higher than the confining element 33. FIG. 3 illustrates a coupling condition of the extendable post 20 and the anchor means 30.

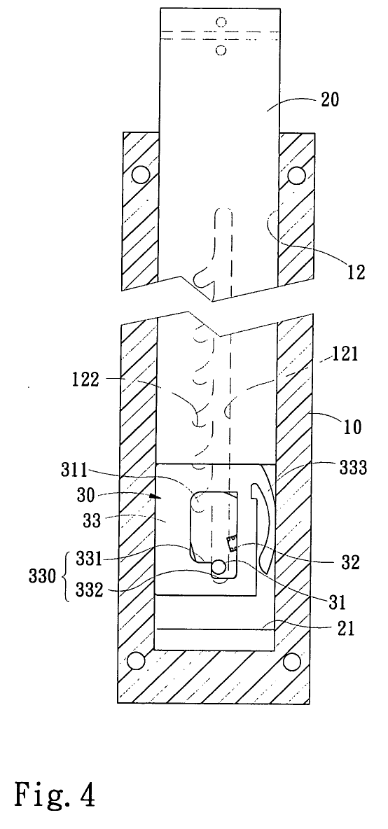

Referring to FIG. 4, when the confining element 33 is slidably located in the switch trough 21, its two sides are in contact with the base 10 under friction in normal conditions. In practice, besides keeping the two sides of the confining element 33 in contact with the base 10 under friction, at least one elastic bucking portion 333 may be added to increase the bucking and frictional effect against the base 10. In an embodiment, the elastic bucking portion 333 is an arched lug extending from the confining element 33.

Refer to FIG. 4 for a condition in which the extendable post 20 is retracted relative to the base 10 to a bottom stop. The confining element 33 is located on the top end of the switch trough 21, and the confining zone 332 is corresponding to the swaying bar 31, and the swaying bar 31 is located on the bottom end of the guiding flute 121.

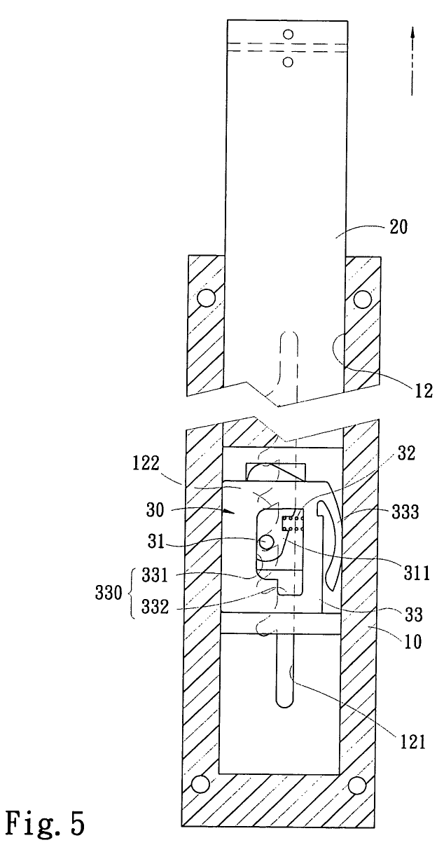

Referring to FIG. 5, when the extendable post 20 is extended outwards to proceed the extending displacement, the confining element 33 is dragged by the base 10 and moved to the bottom end of the switch trough 21, and the action zone 331 is coupled with the swaying bar 31. During the extending process of the extendable post 20, the swaying bar 31 enters and leaves the anchor notches 122 freely from the lower position to the upper position in this order. In this process, if an attempt is made to move the extendable post 20 inversely to proceed the retracting displacement, the swaying bar 31 will be latched in the anchor notch 122. As the swaying bar 31 has already being placed in the anchor notch 122, the confining element 33 is dragged by the base 10 and moved slightly upwards relative to the switch trough 21, but does not switch the confining element 33 to the confining zone 332 to confine the swaying bar 31. Thereby the anchor means 30 makes the extendable post 20 to extend only outwards to proceed the extending displacement without proceeding the retracting displacement. And a one-way anchoring and supporting effect can be achieved. Therefore when users want to adjust the extendable post 20, they can directly pull the extendable post 20 to a desired elevation. The extendable post 30 can be anchored rapidly on the base 10 through the anchor means 30 without relying additional operations.

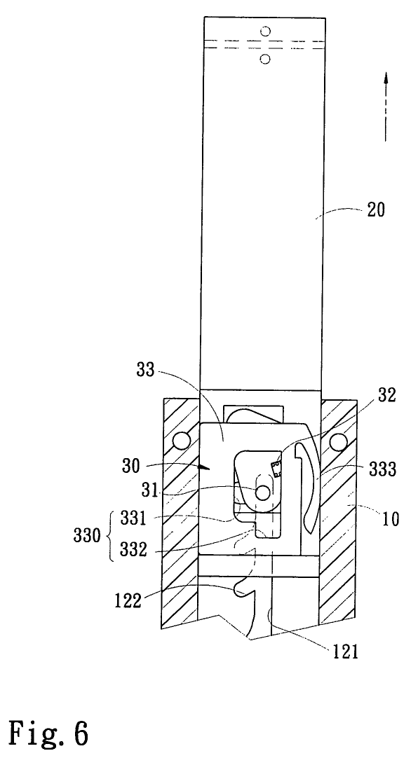

Refer to FIG. 6 for a condition in which the extendable post 20 is extended outwards relative to the base 10 at a top stop. During the extending process of the extendable post 20, the confining element 33 is in contact with the base 10 under friction, hence the confining element 33 is moved to the bottom end of the switch trough 21, and the action zone 331 is corresponding to the swaying bar 31, and the swaying bar 31 is located at the top end of the guiding flute 121.

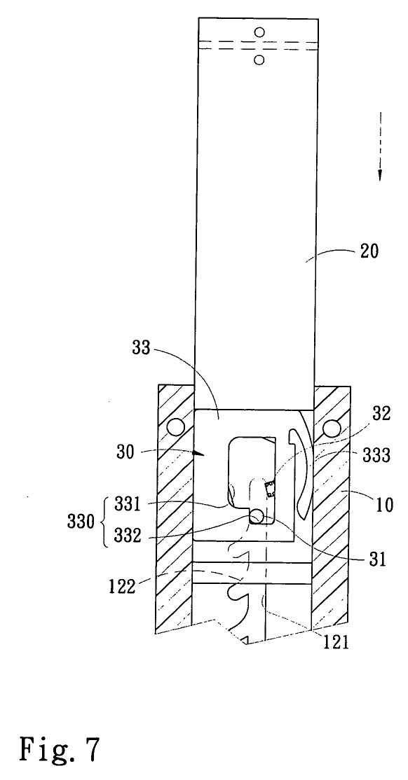

Referring to FIG. 7, after the extendable post 20 was extended to the top stop, and retracting displacement operation is performed, as the confining element 33 is in contact with the base 10 under friction, it is moved to the top end of the switch trough 21 during the retracting process of the extendable post 20, and the swaying bar 31 is located in the guiding flute 121 without hindering the confining element 33; hence the confining element 33 can be switched to confine the swaying bar 31 through the confining zone 332. Thereby the confining element 33 is actuated to confine the swaying bar 31.

While the swaying bar 31 is confined by the confining zone 332, as the swaying bar 31 is in a condition of not being allowed to enter the anchor notch 122, the extendable post 20 can proceed the retracting displacement without being hindered. Moreover, during the retracting process of the extendable post 20, the confining element 33 is in contact with the base 10 under friction and remains at the top end of the switch trough 21, and the swaying bar 31 is confined in the confining zone 332. Hence the swaying bar 31 does not latch in the anchor notch 122 and the extendable post 20 can be retracted without being hindered.

By contrast, during the extendable post 20 is in the retracting process, if the extendable post 20 is moved inversely to proceed the extending displacement, the confining element 33 is in contact with the base 10 under friction and moved to the bottom of the switch trough 21, the confining element 33 is switched to confine the swaying bar 31 through the action zone 331. The condition is resumed to the one shown in FIG. 5.

Based on the previous discussion, the extendable post 20 of the invention can operate relative to the base 10 in the following conditions:
1. The extendable post 20 can be extended outwards relative to the base 10 to proceed the extending displacement and generate an one-way anchoring and supporting effect without retracting.
2. By extending the extendable post 20 to the top stop, the extendable post 20 can be retracted smoothly.
3. Upon retracting, the extendable post 20 can be extended again and resume the one-way anchoring and supporting function.

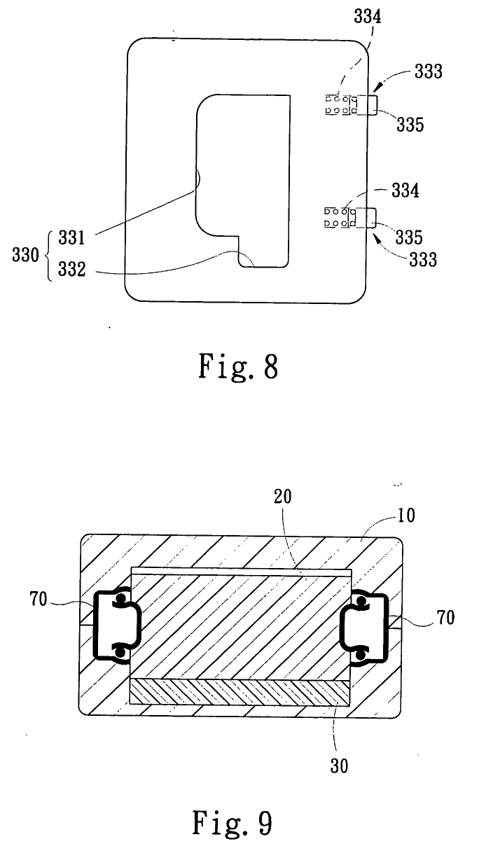

Refer to FIG. 8 for another embodiment of the confining element 33. In this embodiment the confining element 33 has an extending element 334 on the elastic bucking portion 333 and a cap 335 coupling on the extendable element 334 to generate an elastic bucking effect.

Referring to FIG. 9, in order to smooth the extending and retracting process of the extendable post 20 in the extending trough 12, at least one sliding track 70 may be interposed between the base 10 and the extendable post 20 to reduce the resistance during extension and retraction of the extendable post 20.

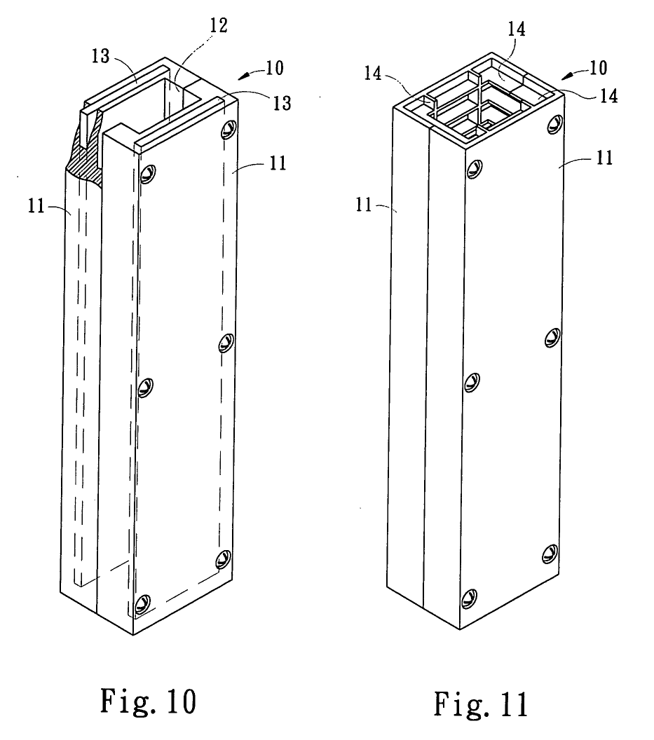

Refer to FIGS. 10 and 11 for various embodiments of the base 10. The base 10 may be fabricated from a metal piece or plastics. In the event that the base 10 is made from plastics, in order to increase the loading strength, the base 10 may be embedded with at least one base supporting layer 13 as shown in FIG. 10. The base supporting layer 13 may be made of metal or a material of a greater loading strength. Referring to FIG. 11, the base 10 may also be reinforced by adding base supporting ribs 14 to enhance the supporting strength.

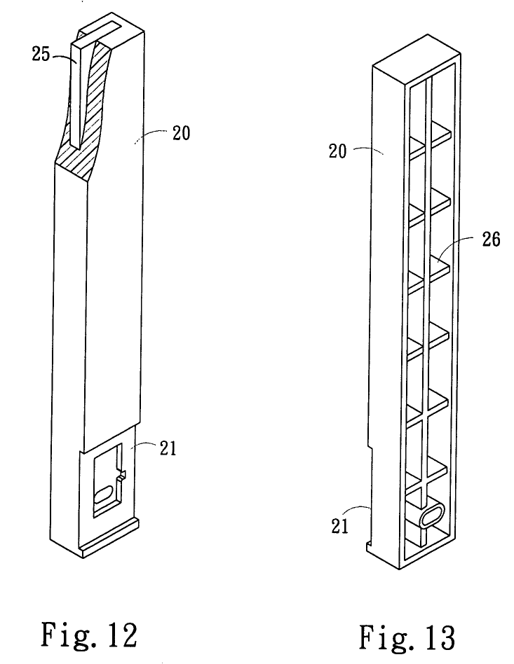

Refer to FIGS. 12 and 13 for various embodiments of the extendable post 20. The extendable post 20 may be fabricated from a metal piece or plastics. In the event that the extendable post 20 is made from plastics, in order to increase the loading strength, the extendable post 20 may be embedded with at least one post supporting layer 25 as shown in FIG. 12. The post supporting layer 25 may be made of metal or a material of a greater loading strength. As shown in FIG. 13, the extendable post 20 may also be reinforced by adding post supporting ribs 26 to enhance the supporting strength.

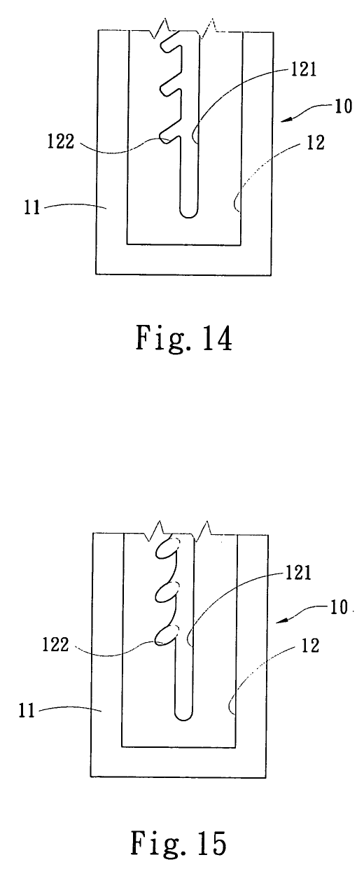

Refer to FIGS. 14 and 15 for various embodiments of the anchor notches 122. FIG. 14 illustrates one type of the anchor notches 122 which have an upward inclined opening. FIG. 15 illustrates another type of the anchor notches 122 which have an arched upward inclined opening and a base contour formed in an elliptic shape.

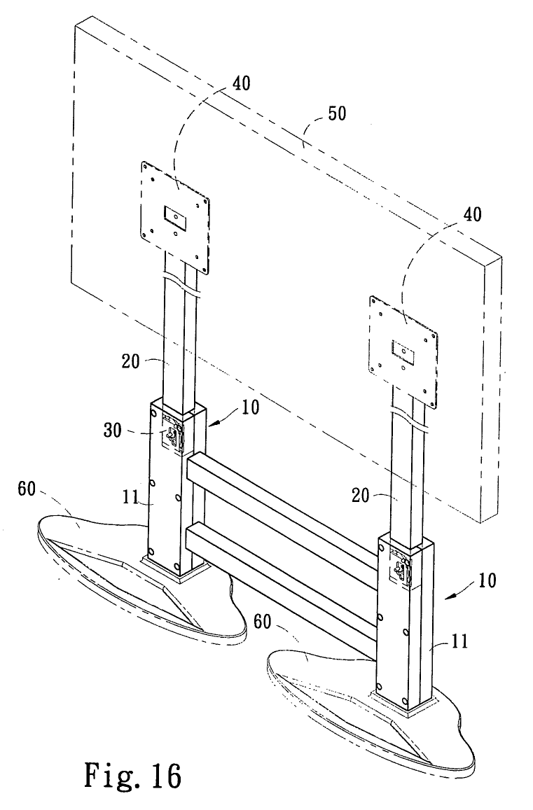

Refer to FIG. 16 for another embodiment to support an article of a greater size or weight more steadily, such as the monitor 50 that is bulkier or heavier. To accomplish this, two or more supporting devices can be disposed at the same time at the bottom of the same article to provide a firmer support. Moreover, the base 10 can be coupled together to enhance supporting stability.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An adjustable supporting device for monitor, comprising at least a base which has an extendable trough, an extendable post which is inserted in the extendable trough and has an extending displacement and a retracting displacement, and an anchor means located on the extendable post to anchor the extendable post on the base; wherein:
the extendable trough has at a trough wall which has at least one guiding flute formed thereon, the guiding flute having a plurality of inclined anchor notches on one side each having a upward opening; and
the anchor means includes at least:
a swaying bar located in the guiding flute;
an elastic element coupling with the swaying bar to urge the swaying bar into the anchor notches such that the extendable post can only proceed the extending displacement without proceeding the retracting displacement to generate an one-way anchoring and supporting condition; and
a confining element abutting the swaying bar to confine the swaying bar from entering the anchor notches, the confining element actuating confining of the swaying bar while the extendable post is located on a top stop and proceeds the retracting displacement so that the extendable post can proceed the retracting displacement without being hindered; confining of the swaying bar being released while the extendable post proceeds the extending displacement to resume the one-way anchoring and supporting condition.

2. The adjustable supporting device for monitor of claim 1, wherein the extendable post has a switch trough at an elevation higher than the confining element to prevent the confining element from sliding into the switch trough; the confining element being in contact with the base under friction and having a step confining trough to harness the swaying bar, the step confining trough having a wider action zone on an upper end and a narrower confining zone on a lower end.

3. The adjustable supporting device for monitor of claim 1, wherein the confining element has at least one elastic bucking portion in contact with the base under friction.

4. The adjustable supporting device for monitor of claim 3, wherein the elastic bucking portion is an arched lug extended from the confining element.

5. The adjustable supporting device for monitor of claim 3, wherein the elastic bucking portion includes an extending element and a cap coupling on the extending element.

6. The adjustable supporting device for monitor of claim 1, wherein the base consists of shells.

7. The adjustable supporting device for monitor of claim 1, wherein the base has at least one base supporting layer.

8. The adjustable supporting device for monitor of claim 1, wherein the base has at least one base supporting rib.

9. The adjustable supporting device for monitor of claim 1, wherein the extendable post has at least one post supporting layer.

10. The adjustable supporting device for monitor of claim 1, wherein the extendable post has at least one post supporting rib.

11. The adjustable supporting device for monitor of claim 1, wherein the base and the extendable post are interposed by a sliding track.

12. The adjustable supporting device for monitor of claim 1, wherein the extendable post has a monitor holding dock on a top end thereof.

13. The adjustable supporting device for monitor of claim 1, wherein the base has a base dock on a bottom end thereof.

14. The adjustable supporting device for monitor of claim 1, wherein each of the anchor notches is inclined in an arched manner and has an upward opening.

15. The adjustable supporting device for monitor of claim 1, wherein each of the anchor notches has a base contour formed in an elliptical fashion and is inclined in an arched manner and has an upward opening.
